(19) United States
(12) Patent Application Publication
(10) Pub. No.: US 2003/0093307 A1
(43) Pub. Date: May 15, 2003

(54) Adaptive networks

(76) Inventors: Alexander Renz, Heidelberg (DE); Ye Chen, Sunnyvale, CA (US); Sudipta Bhattacharya, Irving, TX (US)

Correspondence Address: FISH & RICHARDSON, P.C., 500 ARGUELLO STREET, SUITE 500, REDWOOD CITY, CA, 64063-1526, US

(21) Appl. No.: 10/208,191

(22) Filed: Jul. 31, 2002

Related U.S. Application Data
(60) Provisional application No. 60/336,227, filed on Nov. 14, 2001.
(60) Provisional application No. 60/384,638, filed on May 31, 2002.

(51) Int. Cl. G06F 17/60

(52) U.S. Cl. 705/7; 705/28

(57) ABSTRACT

A method of calculating an order quantity for a product to maintain an inventory level at a future time includes determining an inventory sum and an inventory coefficient of the product over a previous time interval, determining a demand sum and a demand coefficient for the product over the previous time interval, determining an orders sum and an order coefficient for the product over the previous time interval, multiplying the inventory sum and the inventory coefficient to produce an inventory level, the demand sum and the demand coefficient to produce a demand level, and the orders sum and the order coefficient to produce an order level, and summing the inventory level, the demand level, and the order level to obtain the order quantity.

### CROSS-REFERENCE TO RELATED APPLICATIONS

This application claims priority from U.S. Provisional Application No. 60/384,638, filed May 31, 2002, and titled INVENTORY EARLY WARNING AGENT, which is hereby incorporated by reference in its entirety for all purposes.

### TECHNICAL FIELD

This invention relates to commercial supply chain networks.

### BACKGROUND

Today's companies need to adapt to many competitive pressures: financial markets are increasingly demanding that companies use capital more efficiently; businesses are seeking global playing fields to maintain grouwth and diversity risk; customers are demanding mass customization; and, innovation cycles are accelerating.

These pressures on businesses have implications for supply networks: shrinking capital availability is forcing companies to streamline manufacturing and supply operations; information ubiquity is driving and facilitating globalization; shrinking distances to markets requires increased levels of supply network collaboration; customers can more easily determine the real value of products at a time that customer loyalty is diminishing; and a reduction in the time available to build and launch products is pressuring companies to innovate faster.

Ultimately, competitive pressures can push profit margins lower. Manufacturers need to improve efficiency, thereby reducing costs, to survive in highly competitive markets. Supply chain efficiency plays a key role in improving margins and determining the success of manufacturers.

A supply chain is a network of facilities and distribution options that functions to procure materials, transform the materials into semi-finished and finished products, and distribute the finished products to customers. Supply chain management (SCM) is a business policy that aims to improve efficiency of all activities along the supply chain. Good SCM practices result in improved integration and visibility between supply members with more flexibility across the supply network. As a result, building supply networks that are more responsive to changing conditions enhances a company's competitive position.

SAP, AG and SAP America, Inc. provide supply chain management solutions for product manufacturers to help them reach their goals. Some of the solutions are based on the mySAP.com e-business platform (see for further information). One of the building blocks of the e-business platform is the SAP R/3 component that provides enterprise resource planning functionality. The SAP R/3 product includes a Web Application Server (“Web AS”), an R/3 core, and various R/3 extensions.

The SCM Extensions of R/3 provide various planning, coordination, execution, and optimization solutions that are associated with a supply chain. It would be beneficial to provide a web-based or on-line system that adds characteristics of an adaptive network to traditional supply chains to improve the visibility, velocity, and variability of critical information in order to quickly adapt to changing conditions.

### SUMMARY

An adaptive supply chain network possesses flexibility to respond to the environment in near real-time without compromising on operational and financial efficiencies. The network connects supply, planning, manufacturing, and distribution operations to critical enterprise applications and provides near real-time visibility across the supply network, thereby enabling rapid decision-making and execution.

Extraction of the relevant supply chain data from multiple systems across the network and distributing this information to the relevant network nodes is an important feature of an adaptive network. The system provides visibility of the order, automates order management, and monitors product use by customers across the network, replenishing when necessary, without manual intervention.

In one general aspect, a method of calculating an order quantity for a product to maintain an inventory level at a future time includes determining an inventory sum and an inventory coefficient of the product over a previous time interval, determining a demand sum and a demand coefficient for the product over the previous time interval, determining an orders sum and an order coefficient for the product over the previous time interval, multiplying the inventory sum and the inventory coefficient to produce an inventory level, the demand sum and the demand coefficient to produce a demand level, and the orders sum and the order coefficient to produce an order level, and summing the inventory level, the demand level, and the order level to obtain the order quantity.

For example, implementation may include one or more of the following features. The method may include solving for the inventory coefficient, the demand coefficient, and the order coefficient using a linear regression technique. The linear regression technique may solve for the order quantity as defined by the following relationship:

$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j} .$$

The inventory sum may be a real-time inventory sum, the demand sum may be a real-time demand sum, and the orders sum may be a real-time orders sum. Extracting the real-time inventory sum, the real-time demand sum, and the real-time orders sum may be accomplished with a product-tracking device. The product-tracking device may include a radio frequency identification tagging system.

The method may include distributing the order quantity to more than one member of a supply chain network. Distributing the order quantity may include distributing the order quantity over the Internet.

In another general aspect, a method is provided for adapting production of a product in a supply chain network that includes providing a computer system having a network node for each member in a supply chain network, extracting real-time data from the network nodes that includes an inventory sum, a demand sum, and an orders sum during a time interval, calculating an order quantity from the inventory sum, the demand sum, and the orders sum, preparing a production instruction from the order quantity, and adapting manufacture of the product based on the production instruction.

Implementation may include one or more of the features described above or one or more of the following features. For example, the computer system may include an intelligent agent. The intelligent agent may extract real-time data. The intelligent agent may prepare the production instruction according to a set of predefined rules. Adapting the manufacture of the product based on the production instruction may include executing a command, communicating a result to a member of the supply chain network, coordinating a task among members of the supply chain network, or autonomously executing a task by the intelligent agent.

Analyzing the real-time data may include determining if a substitute product is available if a customer order cannot be met from the inventory sum. The method also may include scheduling production of the product if no substitute product is available or routing a fulfillment request to each member of a supply chain network to fulfill a customer order.

The above techniques may all be embodied in an article comprising a computer-readable medium that stores executable instructions for causing a computer system to operate according to the invention as described herein. The computer system may include a client/server architecture or a Web-enabled protocol. Moreover, the techniques could all be utilized in a system that may include at least one database storage unit and at least one processor coupled to the storage unit, wherein the processor is operable to operate as described herein.

The details of one or more implementations are set forth in the accompanying drawings and the description below. Other features and advantages will be apparent from the description, the drawings, and the claims.

### DESCRIPTION OF DRAWINGS

FIG. 1 is a table contrasting characteristics of supply chain networks.

FIGS. 2-3 are simplified graphs illustrating the concept of an adaptive supply chain network.

FIGS. 4-6 are flowcharts of processes associated with an adaptive supply chain network.

FIGS. 7-8 are graphs illustrating demand over a time interval.

FIG. 9 shows a method for calculating an order quantity.

FIG. 10 is a block diagram of a computer architecture to implement an adaptive supply chain network.

FIGS. 11-14 are block diagrams of an intelligent agent architecture.

Like reference symbols in the various drawings indicate like elements.

### DETAILED DESCRIPTION

The adaptive network techniques described herein function to improve the availability and management of information. An adaptive network is a loosely coupled group of organizations that work together to share transactional, operational, and financial data to enhance network competitiveness and optimize network profitability. An adaptive network leverages the integrated and collaborative network to manage variability.

Visibility of timely information is crucial for an adaptive supply chain network as competition transitions from individual companies as competitors to supply networks as competitors. Sharing inter-organizational information facilitates a faster response to changing conditions. Advances in information technology extend visibility across organizations. Information visibility of orders, plans, supplies, inventory, and shipments helps to coordinate events across the network and to foster proactivity.

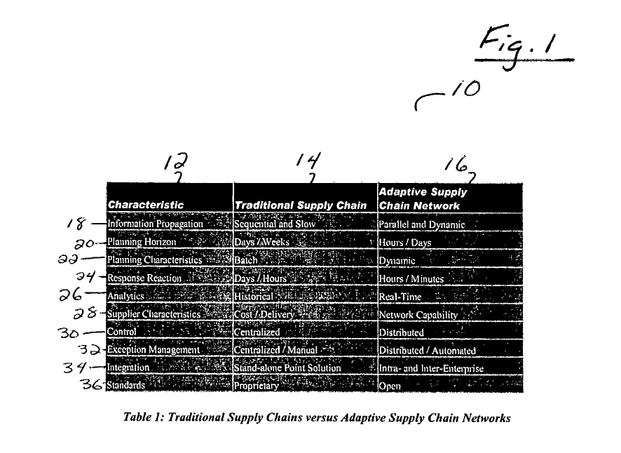

FIG. 1 is a table 10 that compares the characteristics 12 of a sequential supply chain 14 to an adaptive supply chain network 16. The transition to an adaptive network 16 impacts supply chain characteristics 12 that include information propagation 18, planning horizon 20, planning characteristics 22, response reaction 24, analytics 26, supplier characteristics 28, control 30, exception management 32, integration 34, and standards 36. For example, in an adaptive network 16 an order that is captured by a retailer may be simultaneously propagated to suppliers in the network so that inventory checks can be performed against the order at all points. Distributors, logistics service providers, and other relevant network members can have visibility of the order flow into the system and back to the customer.

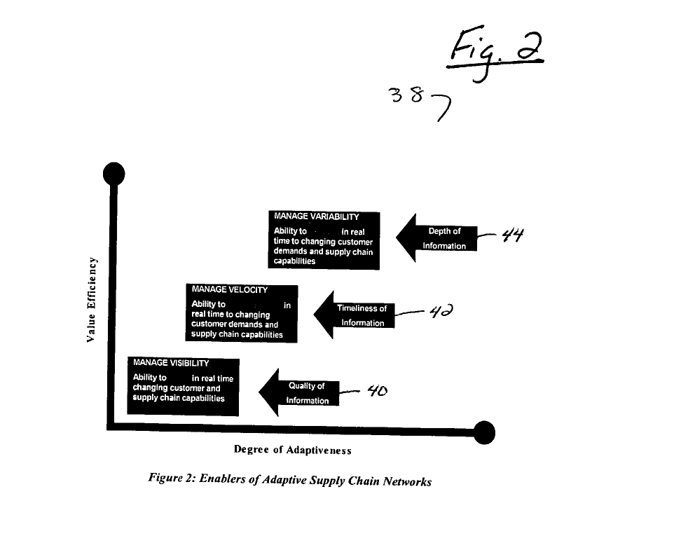

FIG. 2 is a graph 38 that illustrates adaptive supply chain network efficiencies, which improve the quality (visibility) 40, timeliness (velocity) 42, and depth (variability) 44 of information. This is performed by extracting supply chain data from multiple systems across the network and distributing this information to the relevant network nodes. The system is designed to improve total visibility 40 of the order, automate order management, and to monitor product use by customers across the network, replenishing when necessary, without manual intervention.

Improving the velocity 42 of response to information is accomplished by accessing and distributing information rapidly across the supply network. Companies can plan more rapidly and efficiently by moving information and physical assets through the supply network at greater velocities. This enables supply chain members to maintain margin parity with the competition while improving returns on assets and invested capital.

As businesses become more dynamic, demand is less deterministic. Reliance on forecasts using historic data over longer time horizons without utilizing the most current information will yield less than optimal results. Simultaneously, as organizations undergo vertical disintegration to focus on their core competencies, managing variability 44 is a key to efficient operations. Thus, in addition to the rapid distribution of quality information, management of events outside of the organization requires that companies improve access to depths of information to their supply network partners. As mass customization, build-to-order, configure-to-order, engineer-to-order, and assembly postponements all become standard manufacturing practices to manage variability 44, successful network partners can utilize an adaptive network 16 to share information about orders, inventory, short-term and long-term plans, and profit margins.

Adaptivity provides a competitive edge by the ability of the supply network to exchange near real-time information and thereby execute better and faster. As products increase in complexity and need to get delivered faster, product design, design for manufacturability, and distribution become more collaborative efforts among the enterprises in the network. As companies transition to a mass-customization environment supported by a many-to-many relation across the network, the need for collaboration tools such as the adaptive network 16 becomes more critical.

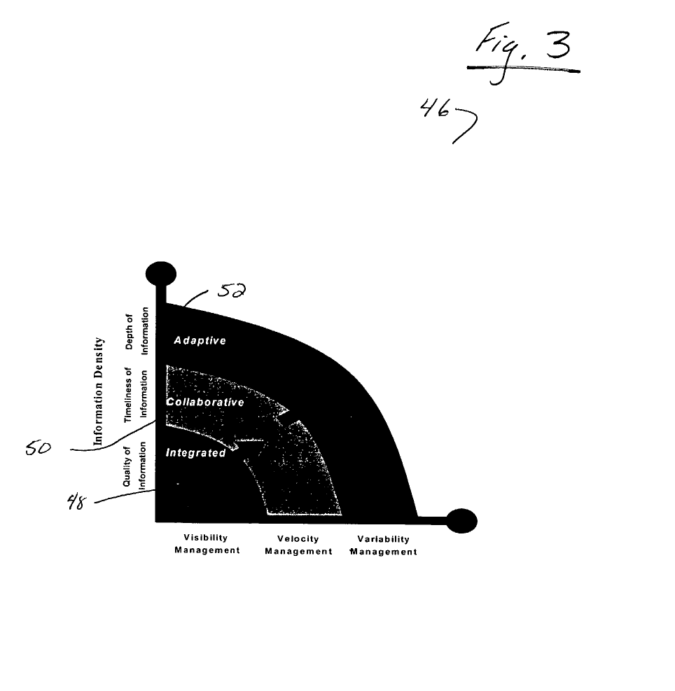

Referring to the graph 46 of FIG. 3, evolution to an adaptive supply chain network 16 is implemented in three phases, which include integration 48, collaborative 50, and adaptive phases 52. In the integration phase 48, new and existing technologies are integrated, such as, for example, relational databases, client/server architecture, TCP/IP network protocols, multimedia, wireless technology, and the Internet.

For example, a company with an internal transportation management system can benefit by integrating its technologies to manage routings, rates, load tendering, and other execution functions. The adaptive network 16 can integrate the company warehouse management system, the enterprise system, the transportation planning and scheduling system, and the supply chain event management application that tracks shipments in transit.

The adaptive network 16 processes discrete, dynamic, and distributed data and applications. The system responds to requests for information and also intelligently anticipates, adapts, and supports users. The adaptive network 16 also coordinates tasks among workers and manages cooperation by supply chain members.

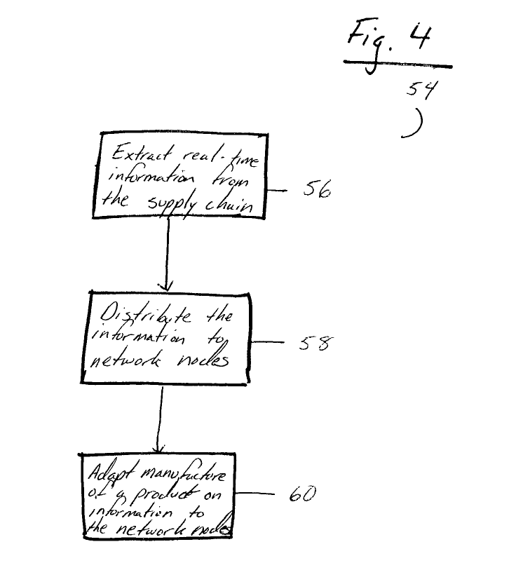

FIG. 4 is a general flowchart 54 associated with an adaptive network. Real-time information is extracted from the supply chain network 56, the information is distributed to network nodes 58, and manufacturing of a product is adapted based on the information provided to the network nodes 60. The real-time information may be derived by a product-tracking device. The real-time data may include sale transaction data, inventory level data, customer order data, or shipment information.

The network nodes may be clients that are configured as data monitoring and data delivery points. The network nodes can include customers and service providers in the supply chain network. Service providers may include supply chain entities, such as, for example, component suppliers, shippers and distributors.

Adapting product manufacture 60 can include management of a variety of supply chain activities, such as, for example, placing supply orders, diverting product shipments, adjusting inventory levels, or adjusting a financial resource. The management activities may be executed autonomously.

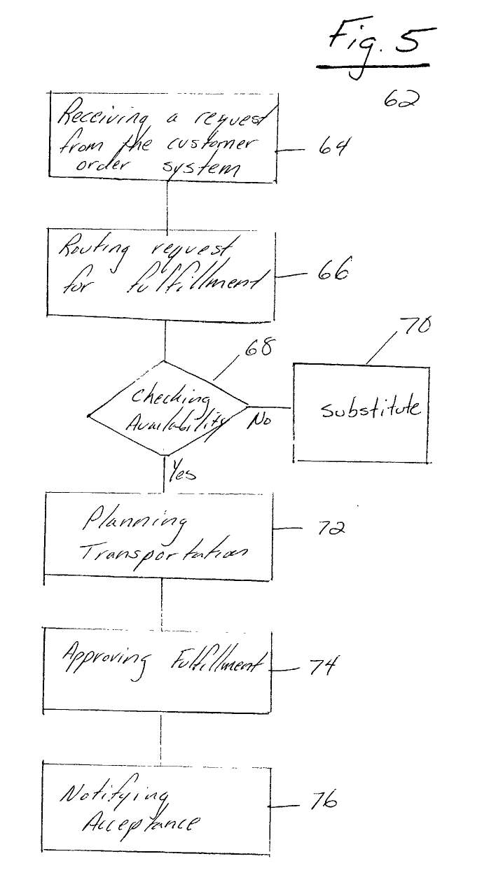

For example, referring to FIG. 5, companies in the adaptive network may use available-to-promise (ATP) methodologies 62. For example, a company receives a direct request from the customer order-entry system of an enterprise system 64. Order promising routes this request instantaneously to all sites that could fill the order 66. The ATP for available and planned inventory is then checked against the date requested by the customer and the appropriate quantities 68. If necessary, substitute choices are offered 70. The ATP results are sent to the transportation-planning engine of either the customer or the logistics service provider to determine transportation time and delivery dates 72. The results go back to the order-promising engine, which selects the fulfillment site and responds to the customer-order service application for approval 74. Order acceptance is then propagated back through the system, notifying the supply chain members of the order acceptance 76. If the material isn't available, the order promising system can use the capable-to-promise functionality to address the production-scheduling engine and establish a date for the products promised.

In order to perform these and other tasks, adaptive technology employs intelligent software agents. Intelligent agents are packets of software capable of sensing the local environment, autonomously executing delegated tasks, and communicating results to designated entities, including human users, agents, applications, or business workflows. Agents improve visibility into real-time distributed business processes across the supply network.

Several agents—each supporting a clearly discernible task or process—may interact with each other in a specified environment. The agents may execute a wide range of functional tasks, such as searching, comparing, learning, negotiating, and collaborating. These capabilities enhance the adaptability of the supply network, reduce variability and the costs associated with exception management, and address barriers to widespread collaboration among supply network partners.

Agent-based systems complement enterprise resource planning (ERP) systems by leveraging their transactional data while providing flexibility. An agent-based system may have a modular design to allow individual agents to be flexibly removed or exchanged with more advanced agents, which also improves fault-tolerance and provides a self-organizing adaptive network. Agents also may be deployed to manage assets (for example, inventories and capacities) across company boundaries.

Adaptive agents enable and automate information exchange in the network, thereby supporting the instant propagation of information across the network and allowing companies to make more intelligent decisions. Adaptive agents also increase the value of business transactions by allowing for real-time, active, and predictive monitoring of critical business events and parameters across the extended supply network.

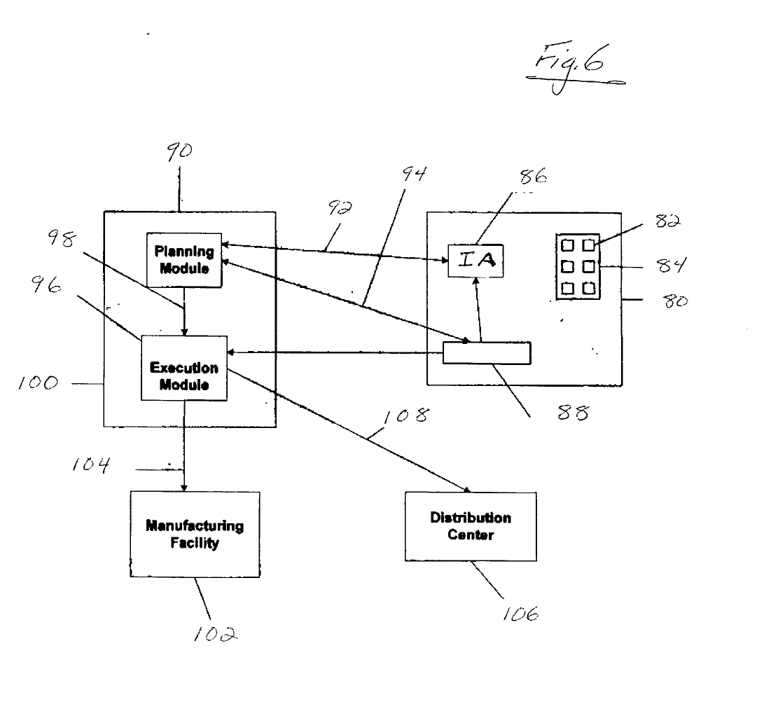

For example, referring to FIG. 6, an adaptive network can utilize intelligent agents to minimize inventory without running out of stock. A store 80 may want to have a minimum quantity of items 82 on a shelf 84 at any particular time such that the shelf can be stored with a large variety of items. By limiting the quantity of a particular brand on a shelf at any particular time, a grocery store can display more brands on that shelf. To accomplish this type of shelving scenario, the store must carefully monitor the amount of stock on the shelf on a real time basis to prevent the shelf from emptying out. Currently, many stores use their employees to visually monitor empty space on the shelf and replenish the shelf when it looks empty. This is labor intensive and inexact.

The intelligent agent 86 receives shelf quantity data from a shelf-monitoring program 88 that, for example, monitors the quantity of a particular SKU number on the shelf. When an item 82 is scanned at the cash register, a database that contains the shelf location of the item is accessed and the program reduces the number of items on that shelf 84 by the number of items being purchased at that time. The intelligent agent 86 then uses algorithms to determine when to send an order to replenish the shelf 84 with items of that particular SKU. When the quantity of items 82 on the shelf 84 reaches a certain level, the intelligent agent 86 sends a message to a planning module 90 along a first message path 92. The planning module 90 then sends return messages to the intelligent agent 86 along the first message path 92 and to the shelf-monitoring program 88 along a second message path 94. The shelf-monitoring program 88 then sends a return message to the planning module 90 along the second message path 94. Next, the planning module 90 sends a message to an execution module 96 along a message path 98. The planning module 90 and the execution module 96 may be components within a supply chain management application 100 or may be separate stand-alone components. After receiving the message from the planning module 90, the execution module 96 sends a first message to a manufacturing facility 102 along a message path 104 and a second message to a distribution center 106 along a message path 108. Based on this series of messages, the store is able to replenish its shelf with the item 82.

The intelligent agent 86 also can be used when the shelf is replenished. For example, the shelf-monitoring program 88 sends a message to the execution module 96 along the second message path 94, which sends a message to the distribution center 106 along the message path 108. These messages are used to update the distribution center of the amount of stock on the shelf 84.

At another level, a store can use an intelligent agent to monitor the levels of an item on the shelf and in the inventory for one or more items. When items are sold, for example, by being scanned at a cash register, the intelligent agent takes that sales data and uses algorithms to determine whether and when to send an order to replenish the shelf and/or order more of that item from a warehouse or distribution center.

At an even higher level, a warehouse or distribution center can use an intelligent agent to monitor the levels of an item within the warehouse, such as on shelves, on pallets, in quarantine, or at another location within the warehouse. Customers of the warehouse, such as a retailer or a factory, order the item from the warehouse. For example, a consumer product goods (“CPG”) retailer may order a pallet load of an item, which the warehouse operator loads onto a delivery truck of either the warehouse, the retailer, or a third party logistics supplier. When the pallet is loaded on the truck, the warehouse operator may use a wireless communications device to notify the inventory management software that a pallet-load of a particular item has been transferred from the warehouse. Either a wireless communications device or the inventory management software may be programmed to notify the intelligent agent that a pallet-load of the particular item has been transferred from the warehouse.

The wireless communications device may utilize radio frequency identification (RFID) tagging. RFID tags are thin, flexible smart labels containing a silicon chip. The tags may be attached to or embedded in products, boxes, and pallets, to create a people-free, wireless environment for tracking items as they travel through the supply chain. As a tag moves past a “read point” in the supply network, through different distribution centers, or through retail stores, its unique ID is automatically communicated back to a central database. This allows managers to pinpoint product location in real-time and to make real-time decisions. RFID technology does not require line-of-sight to communicate and tags can survive in harsh environments such as extreme temperatures, moisture, and rough handling.

RFID technology also may be coupled with intelligent agents to execute functional tasks, such as, for example, issuing purchase orders or advance-ship notices within the distribution centers. Agent technology and RFID technology complement each other and can significantly enhance the adaptivity of a supply network. Agent technology helps to manage the large volumes of data captured through RFID readers and helps to make intelligent decisions based on pre-configured rules.

As explained in the scenarios above, an intelligent agent can be programmed as a predictive and adaptive inventory management application that can be used to monitor and predict future inventory levels by modeling variability in both demand and supply related supply chain activities. The agent utilizes learning techniques that can estimate potential variation in inventory levels in the near future in order to identify potentially risky situations early enough to allow for corrective measures. Machine-learning techniques may be used to recognize patterns of behavior from historical data around consumption and replenishment and around the performance of resources and supply chain partners.

Optimal supply chain conditions ensure that the supply chain members have adequate quantities of stock to meet their needs while also minimizing excessive inventory levels. The agent uses a statistical analysis to predict an optimal inventory level with upside and downside confidence bounds. Predictive data used by the agent includes, for example, demand, orders, and inventory.

The agent's forecasting model attempts to utilize point-of-sales data immediately as it is generated in order to accurately predict future orders or to evaluate already planned orders for possible changes. The order to replenish at some future time is represented by t′. The information set in real-time is expressed as:

Iₜ^{r}={{x_{τ},τ≦t}, {i_{τ},τ≦t}, {s_{τ},τ≦t}, {o_{τ},τ≦t}}

where:

time tε□

iₜ—inventory at the beginning of period (day) t (measured after the day's shipment arrives)

xₜ—total demand during the period t (a realization of a random variable)

sₜ—quantity ordered at the beginning of the period t (after the inventory is measured) to be received after l periods (at the beginning of the period t+l)

oₜ—items on order as of the beginning of period t (measured after the day's shipment arrives)

αₜ—quantity arrived at the beginning of period t (equals to sₜ₋ₗ)

□t_{y} (assumed to be a positive integer) is the information delay for the variable y.

However, the agent model must take into account the time-lag between when information is generated and when it is actually used. A number of circumstances can cause a delay between the generation of the point-of-sales data and actual order generation. For example, time delays may occur in orders placed by a store chain corporate center to a manufacturer and in orders placed by a distribution center as a result of aggregated/accumulated demand from individual stores.

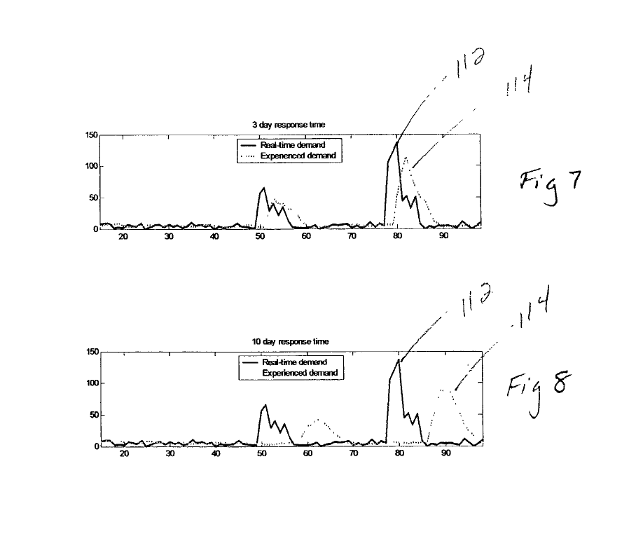

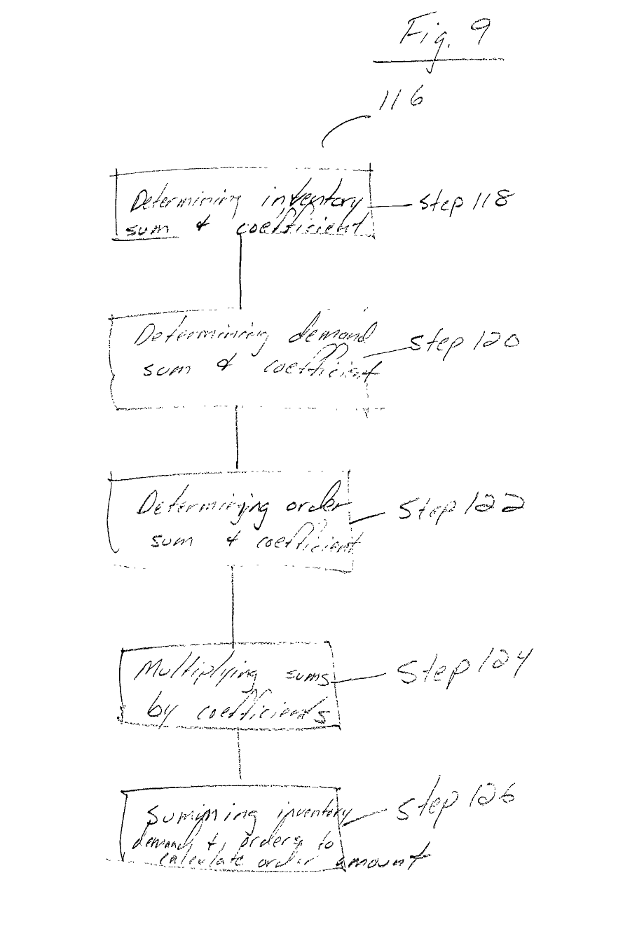

As a result, supply chain decisions, such as, for example, new replenishment or manufacturing orders, may not reflect up-to-date point-of-sales data. Referring to FIGS. 7 and 8, changes in the real-time customer demand 112 propagate into orders, referred to as experienced demand 114, with a time lag. Because of this time delay, the information set of a decision maker, when placing an order at time t, consists of the following:

Iₜ^{o}={{x_{τ},τ≦t−□tₓ}, {i_{τ},τ≦t−□tᵢ}, {s_{τ},τ≦t−□tₛ}, {o_{τ},τ≦t−□tₒ}}

Accounting for this time lag requires the agent to “extract” the decision makers' ordering policies from the available data and then to “make” ordering decisions before they are actually made by the decision maker. However, even with real-time data the ordering policy “extraction” may never be perfect. For example, at time t the agent predicts an order that will be placed by a decision maker at time t+□t. Depending on the exact value of the □t, the information set available for the estimation of future orders, Iₜ^{r}, may not contain all the information in the I_{t+□t}^{r}. Thus, even if the agent extracts the order information perfectly, the estimate may differ from the actual result.

The agent estimates a set of functions f_{t+□t}(Iₜ^{r}), □tε{1, . . . , T}, each of which minimizes an appropriately selected distance function d between an approximation and the actual order: d(fₜ₊₁(Iₜ^{r})−oₜ₊₁). The agent model assumes that the planned/forecasted orders already in the system can be updated (quantity changed, orders cancelled, etc.) when new information becomes available and that there is a causal relationship between the orders in the near-term future and current point-of-sales data.

The agent model simulates two separate processes that govern the ordering policy:

1. Ordering as a result of experienced consumer demand; and

2. Ordering to stock-up in anticipation of future promotions.

Therefore, an order placed at time t is a composition of orders resulting from both of the above processes.

The agent model assumes that store ordering decisions are aimed at keeping the inventory low, while at the same time not running out of stock. The inventory equation can be described as:

iₜ₊₁=iₜ+αaₜ₊₁−xₜ=iₜ−xₜ+sₜ₊₁₋ₗ

In this equation, the inventory at time t+1 (iₜ₊ₗ) is expressed as the inventory at time t (iₜ) and the arrival of stock at time t+1 (αₜ₊₁) minus the demand at time t (xₜ). The orders placed at a previous time t+1−l (sₜ₊₁₋ₗ) can be substituted for the arrival of stock at time t+1 (αₜ₊₁).

Stores often make decisions about the quantity to be ordered at the beginning of the day t by keeping the expected or desired inventory at the beginning of the day t+l (after l's day shipment arrives) equal to the model stock m:

sₜ=m+f_{t,t+l-1}−oₜ−iₜ,

where f_{t,t+l-1} is the expected total consumption in the periods from t to t+l−1.

The items on order at a particular time oₜ₊₁ is expressed as:

oₜ₊₁=oₜ+sₜ−αₜ₊₁=oₜ+sₜ−sₜ₊₁₋ₗ

In this equation, orders at time t+1 (oₜ₊₁) is expressed items on order at time t (oₜ) and stock ordered at time t (sₜ) minus stock that arrived at time t+1 (αₜ₊₁). The amount of stock ordered at time t+1−1 (sₜ₊₁₋ₗ) can be substituted for the stock that arrived at time t+1.

Thus, the amount ordered at a particular time t+1 is a linear combination of an earlier order and sales. An order at time t+1 can be expressed as a linear combination of point-of-sale, order and inventory levels from previous periods.

As mentioned above, one of the main objectives of supply chain management is to keep the inventory low, while minimizing the out of stocks probability at the same time. Combining the equations above, an ordering policy can be based on linear or near linear algorithms expressed as:

$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$

where the variable coefficients (α,β,γ) are solved by linear regression techniques.

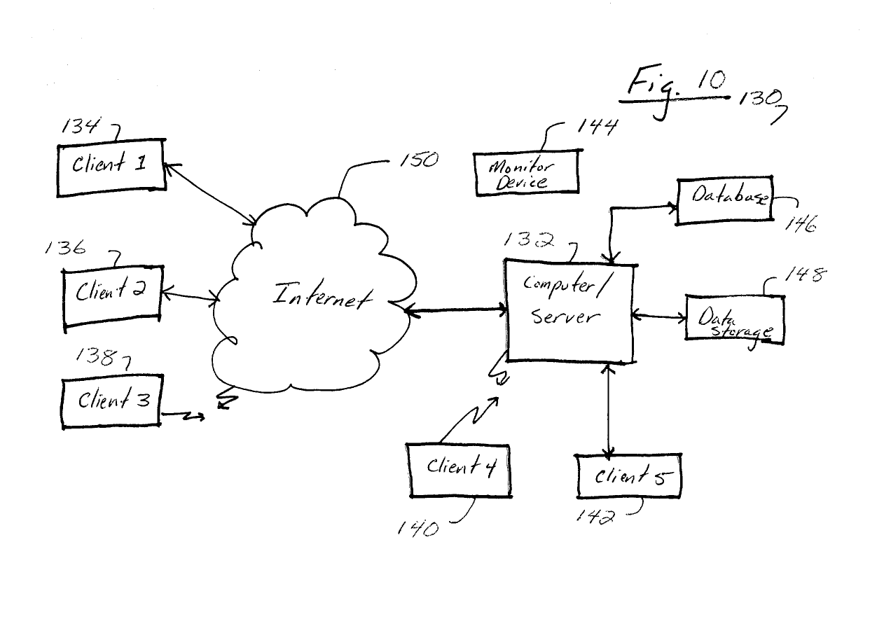

Referring to FIG. 9, the equation above can be expressed as a method of calculating an order quantity to maintain an inventory level at a future time 116. The method 116 includes determining an inventory sum and an inventory coefficient of the product over a previous time interval (step 118), determining a demand sum and a demand coefficient for the product over the previous time interval (step 120), determining an orders sum and an order coefficient for the product over the previous time interval, (step 122), multiplying the inventory sum and the inventory coefficient to produce an inventory level, multiplying the demand sum and the demand coefficient to produce a demand level, and multiplying the orders sum and the order coefficient to produce an order level (step 124), and summing the inventory level, the demand level, and the order level to obtain the order quantity (step 126).

The inventory sum in step 118, the demand sum in step 120, and the orders sum in step 122 are calculated from historic information. In one implementation, real-time information is extracted by an RFID tagging system (see FIG. 6 above) over the time period t−l to t. The inventory sum is a summation of the inventory variable (iⱼ) over the time period from t−l to t. The demand sum is a summation of the demand variable (xⱼ) over the time period from t−l to t. The orders sum is a summation of the order variable (oⱼ) over the time period from t−l to t.

The method 116 may further include solving for the inventory coefficient (α), the demand coefficient (β), and the orders coefficient (γ) using linear regression techniques. In other implementations, the coefficients may be estimated using an autocorrelation analysis. In a further implementation, the results may be cross-correlated against other algorithms, for example, a classification and regression decision tree algorithm. This algorithm check is particularly useful in order to account for certain variability, such as, for example, seasonal or daily variations in consumer demand.

The architecture of the adaptive network facilitates cross-enterprise collaboration by utilizing standardized Web services technology to allow firms to interconnect software systems quickly and cheaply. The Web services technology in the adaptive network 16 builds on Internet technologies, such as, for example, transmission control protocol/Internet protocol (TCP/IP) and extensible markup language (XML). In addition, the adaptive network may be implemented using newer standards, such as, for example, simple object access protocol (SOAP), web services description language (WSDL), and universal description, discover and integration (UDDI). Portals also may be utilized by the adaptive network.

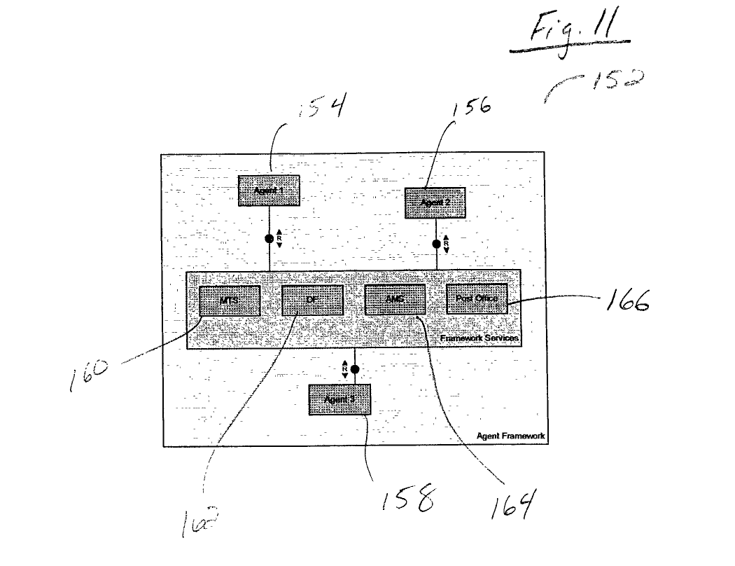

FIG. 10 is a simplified block diagram of a computerized or on-line system 130 to implement an adaptive supply chain network. A programmable computer or server 132 may be configured to run one or more application programs. Agent Management Service processes data and provides results in response to requests from client computers 134, 136, 138, 140, 142. The server 132 may be connected to a supply chain monitor device 144, a database 146 and a data storage unit 148. The computer or server 132 and the client computers 134-142 may be any general-purpose programmable computer, such as IBM-type personal computers or Apple-type computers. Alternatively, the client computers may be any type of portable electronic data device capable of sending and receiving data, such as a personal digital assistant (PDA). The computer or server 132, client computers 134-142, database 146, and data storage unit 148 may all be in different locations, and may communicate via a network connection, via the internet 150 and/or over wireless connections or other communication links. Authorized manufacturing employees can utilize client computers to access the server 132 over direct or wireless connections via the Internet 150, or by direct or wireless network connections, as shown. The server 132 may contain various application programs, which are utilized by the authorized employees to determine how best to manage the adaptive network 16 under various circumstances.

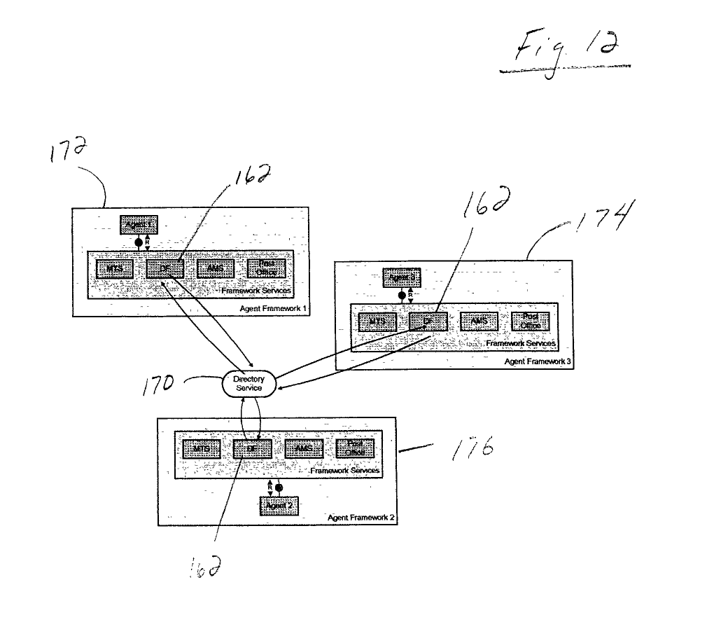

FIG. 11 shows the significant features of the agent framework architecture 152. Agent framework architecture is a container that provides programmatic support for agents. For example, the agent framework may be implemented in Java code that runs in a single virtual machine on a particular host. The agent may provide the following services to support the agents running inside the framework: life cycle management, directory services, communication, configuration, logging, persistence, and notification. The figure shows three agents 154, 156, 158 each communicating with the following local services: Message Transport Service 160, Directory Facilitator 162, Agent Management Service 164, and Post Office (PO) 166.

Agent Management Service 164 provides lifecycle management facilities within the agent framework. Agent Management Service 164 allows administrators and control agents to manage the execution of other agents by stopping, starting and suspending agents. Agent Management Service 164 provides agent lifecycle management facilities within a particular agent framework.

Message Transport Service 160 is service provided to allow agents to send AclMessages to other agents. An AclMessage encapsulates a communication between two agents much like an email message, in that it specifies a sender, recipient, subject, and message content.

Directory Facilitator 162 is a service that provides the agents with access to a central Directory Service. Directory Service provides identity (white page) and capability (yellow page) search facilities across an agent community. There is one Directory Service for one agent community. A directory service might be federated with the Directory Service for another agent community. Post Office 166 is a service provided by a particular agent framework to receive and maintain AclMessages addressed to the agents within that framework.

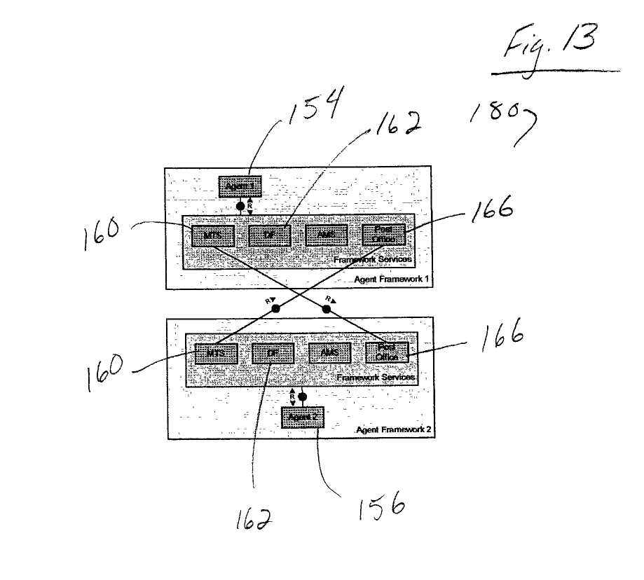

FIG. 12 shows an implementation of the Directory Service. The Directory Service is a centralized service that plays an important role in unifying the agent community. The service may be implemented using, for example, the Java Naming and Directory Interface (JNDI). FIG. 12 shows three agent frameworks. For simplicity, each framework contains a single agent. Each framework runs on a different host machine 172, 174, 176. The directory facilitator 162 in each framework updates the directory service 170, registering new agents as they are started up, and deregistering agents as they are shut down. The directory service 170 then allows agents to search for other agents, both by identity (white page) and capability (yellow page). The Directory Facilitator 162 provides access to this functionality within each agent framework.

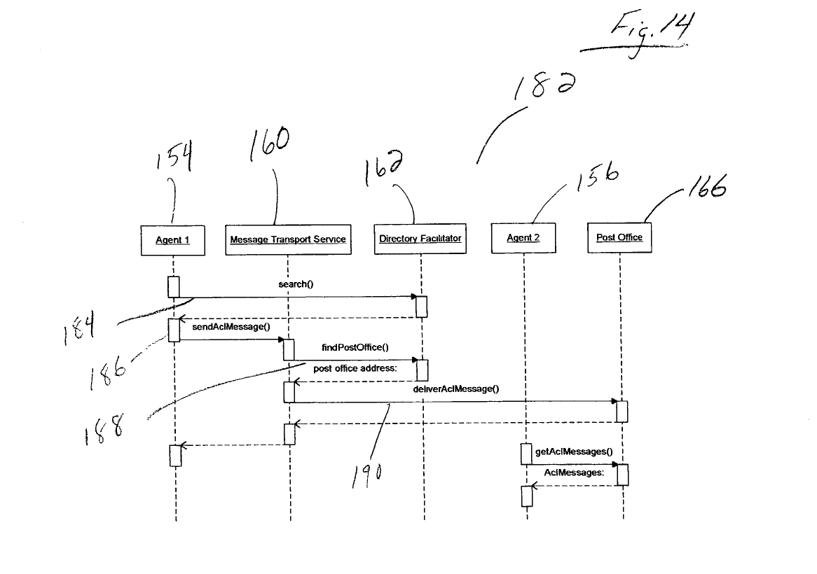

FIG. 13 shows another aspect of the agent community—the messaging architecture 180. If Agent 2 156 requires the type of service provided by Agent 1, it uses its Directory Facilitator 162 to perform a capability directory lookup. The Directory Facilitator 162 informs Agent 2 156 that Agent 1 154 is capable of the type of service that it desires. Agent 2 then formulates an AclMessage and asks its local Message Transport Service 160 to deliver that message. The Message Transport Service 160 uses the Directory Facilitator 162 to locate the Post Office 166 for Agent 1 154, and delivers the message to that Post Office 166.

In one implementation, Java's Remote Method Invocation (RMI) is used by the Message Transport Service 160 to deliver the message to the Post Office 166. Flexibility in the framework design allows the usage of other message transport mechanisms by the Message Transport Service 160 such as SOAP, JMS, CORBA, and JINI.

FIG. 14 shows a sequence diagram 182 for a simple communication scenario between agents. In this scenario, Agent 1 154 wishes to send a message to Agent 2 156. The diagram shows the sequence of messages between participating objects to accomplish this scenario. First, Agent 1 154 invokes the searchDirectory method 184, which is processed by the Directory Facilitator 162. Agent 1 154 creates an AclMessage and retrieves Agent 2's identification from the search result, setting this into the message's recipient field. Agent 1 154 then invokes the sendAclMessage 186, which is processed by the Message Transport Service 160. The Message Transport Service 160 uses the Directory Facilitator 162 to find the Post Office address 188 for Agent 2. The Message Transport Service then delivers the message 190 to that Post Office. Agent 2 then retrieves the message 192 from the Post Office for processing.

A number of implementations have been described. Nevertheless, it will be understood that various modifications may be made without departing from the spirit and scope of the adaptive supply chain network. Accordingly, other implementations are within the scope of the following claims.

What is claimed is:

1. A method of calculating an order quantity for a product to maintain an inventory level at a future time, the method comprising:
determining an inventory sum and an inventory coefficient of the product over a previous time interval;
determining a demand sum and a demand coefficient for the product over the previous time interval;
determining an orders sum and an order coefficient for the product over the previous time interval; and
multiplying the inventory sum and the inventory coefficient to produce an inventory level, the demand sum and the demand coefficient to produce a demand level, and the orders sum and the order coefficient to produce an order level; and
summing the inventory level, the demand level, and the order level to obtain the order quantity.

2. The method of claim 1 further comprising solving for the inventory coefficient, the demand coefficient, and the order coefficient using a linear regression technique such that calculating the order quantity is defined by the following relationship:
$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$
wherein: sₜ₊ₖ is the order quantity; αⱼ is the inventory cofficient; iⱼ is an inventory variable for detemining the inventory sum; βⱼ is the demand cofficient; xⱼ is a demand variable for detemining the demand sum; γⱼ is the orders cofficient; and oⱼ is an orders variable for detemining the orders sum.

3. The method of claim 1 wherein the inventory sum is a real-time inventory sum, the demand sum is a real-time demand sum, and the orders sum is a real-time orders sum.

4. The method of claim 3 further comprising extracting the real-time inventory sum, the real-time demand sum, and the real-time orders sum with a product-tracking device.

5. The method of claim 4 wherein the product-tracking device includes a radio frequency identification tagging system.

6. The method of claim 3 further comprising distributing the order quantity to more than one member of a supply chain network.

7. The method of claim 6 wherein distributing the order quantity includes distributing the order quantity over the Internet.

8. A method of adapting production of a product in a supply chain network comprising:
providing a computer system having a network node for each member in a supply chain network;
extracting real-time data from the network nodes that includes an inventory sum, a demand sum, and an orders sum during a time interval;
calculating an order quantity from the inventory sum, the demand sum, and the orders sum;
preparing a production instruction from the order quantity; and
adapting manufacture of the product based on the production instruction.

9. The method of claim 8 wherein calculating the order quantity is defined by the following relationship:
$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$
wherein: sₜ₊ₖ is the order quantity; αⱼ is the inventory cofficient; iⱼ is an inventory variable for detemining the inventory sum; βⱼ is the demand cofficient; xⱼ is a demand variable for detemining the demand sum; γⱼ is the orders cofficient; and oⱼ is an orders variable for detemining the orders sum.

10. The method of claim 8 wherein:
providing the computer system includes providing the computer system with an intelligent agent; and
extracting the real-time data includes extracting the real-time data with the intelligent agent.

11. The method of claim 10 wherein the computer system includes a set of predefined rules and preparing the production instruction includes preparing the production instruction with the intelligent agent according to the set of predefined rules.

12. The method of claim 10 wherein adapting manufacture of the product based on the production instruction includes executing a command by the intelligent agent.

13. The method of claim 10 wherein adapting manufacture of the product based on the production instruction includes communicating a result to a member of the supply chain network by the intelligent agent.

14. The method of claim 10 wherein adapting manufacture of the product based on the production instruction includes coordinating a task among members of the supply chain network with the intelligent agent.

15. The method of claim 10 wherein adapting manufacture of the product based on the production instruction includes autonomously executing a task by the intelligent agent.

16. The method of claim 8 wherein providing the computer system includes providing the computer system with a client/server architecture.

17. The method of claim 8 wherein the providing the computer system includes providing the computer system with a Web-enabled protocol.

18. The method of claim 8 wherein the computer system includes a database and further comprising storing the real-time data on the database.

19. The method of claim 8 wherein the computer system includes a processor and further comprising analyzing the real-time data on the processor.

20. The method of claim 19 wherein analyzing the real-time data further includes determining if a substitute product is available if a customer order cannot be met from the inventory sum.

21. The method of claim 19 further comprising scheduling production of the product if no substitute product is available.

22. The method of claim 8 wherein adapting manufacture of the product includes routing a fulfillment request to each member of the supply chain network to fulfill a customer order.

23. An article comprising a computer readable medium that stores executable instructions for causing a computer system to:
extract real-time data from a supply chain network that includes an inventory sum, a demand sum, and an orders sum;
calculate an order quantity from the real-time data;
adapt manufacture of a product based on the order quantity.

24. The article of claim 23 wherein the order quantity is calculated by the computer system according to the following relationship:
$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$
wherein: sₜ₊ₖ is the order quantity; αⱼ is the inventory cofficient; iⱼ is an inventory variable for detemining the inventory sum; βⱼ is the demand cofficient; xⱼ is a demand variable for detemining the demand sum; γⱼ is the orders cofficient; and oⱼ is an orders variable for detemining the orders sum.

25. An article comprising a computer readable medium that stores executable instructions for causing a computer system to:
extract real-time data from a supply chain network with a radio frequency identification tagging system;
process the real-time data to produce a production instruction that includes an order quantity; and
adapt manufacture of a product based on the production instruction.

26. The article of claim 25 further comprising instructions to solve for the order quantity from the real-time data according to the following relationship:
$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$
wherein: sₜ₊ₖ is the order quantity; αⱼ is the inventory cofficient; iⱼ is an inventory variable for detemining the inventory sum; βⱼ is the demand cofficient; xⱼ is a demand variable for detemining the demand sum; γⱼ is the orders cofficient; and oⱼ is an orders variable for detemining the orders sum.

27. An article comprising a computer readable medium that stores executable instructions for causing a computer system to:
extract information from each service provider in a supply chain network;
analyze the information to produce an order quantity defined by the following relationship:
$${s}_{t + k} = {\sum }_{j = t - l}^{t} {α}_{j} {i}_{j} + {\sum }_{j = t - l}^{t} {β}_{j} {x}_{j} + {\sum }_{j = t - l}^{t} {γ}_{j} {o}_{j}$$
wherein:
sₜ₊ₖ is the order quantity; αⱼ is the inventory cofficient; iⱼ is an inventory variable for detemining the inventory sum; βⱼ is the demand cofficient; xⱼ is a demand variable for detemining the demand sum; γⱼ is the orders cofficient; and oⱼ is an orders variable for detemining the orders sum; and
adapt manufacture of a product based on the order quantity.

28. The article of claim 27 further comprising instructions to include inventory information, order information, and demand information in the information extracted from the supply chain network.

29. A method of managing inventory in a supply chain network comprising:
tracking inventory in a supply chain network with a radio frequency identification tagging system to produce inventory data;
analyzing the inventory data with an intelligent agent to produce an inventory report; and
executing an inventory management task from the inventory report.

30. The method of claim 29 wherein executing the inventory management task is performed by the intelligent agent.

31. A method of managing inventory in a supply chain network comprising:
tracking inventory in a supply chain network in real-time with a product tracking device to produce real-time inventory data;
analyzing the real-time inventory data with an intelligent agent to produce a real-time inventory report; and
executing an inventory management task from the real-time inventory report with the intelligent agent.
